(19) United States
(12) Patent Application Publication
(10) Pub. No.: US 2026/0368372 A1
(43) Pub. Date: Nov. 19, 2026

(54) TAMPER INDICATION DEVICES

(71) Applicant: HEWLETT PACKARD ENTERPRISE DEVELOPMENT LP, Spring, TX (US)

(72) Inventors: Lee A. Preimesberger, Houston, TX (US); Vartan Yosef Kasheshian, Houston, TX (US); Jonathan Rene Mooty, Houston, TX (US)

(21) Appl. No.: 19/208,818

(22) Filed: May 15, 2025

(51) Int. Cl. G06F 21/79; G06F 21/87; G08B 13/12

(52) U.S. Cl. CPC G06F 21/79; G06F 21/87; G08B 13/128

(57) ABSTRACT

In some examples, a tamper indication device includes a tamper visual layer physically deformable to visually indicate tampering. The tamper indication device includes a control circuit having a wireless transceiver and a memory storing a secret. The control circuit receives a challenge value provided by an external device, and generates a challenge response value based on the challenge value and the secret. The control circuit stores the challenge response value in the memory, where the challenge response value is readable from the memory as part of a tamper detection process performed by the external device.

### BACKGROUND

Physical items may be subjected to tampering by unauthorized persons. For example, during shipment of a physical item between different locations, an attacker may remove the packaging in which the physical item is contained to modify the physical item or access content of the physical item (e.g., access information stored in an electronic device).

### BRIEF DESCRIPTION OF THE DRAWINGS

Some implementations of the present disclosure are described with respect to the following figures.

FIG. 1 is a block diagram of an arrangement including a tamper indication device, a physical item, and a verifier device, according to some examples.

FIG. 2 is a flow diagram of a write handling process of a control circuit of the tamper indication device, according to some examples.

FIG. 3 is a flow diagram of a read handling process of the control circuit of the tamper indication device, according to some examples.

FIG. 4 is a block diagram of a tamper indication device according to some examples.

FIG. 5 is a block diagram of a storage medium storing machine-readable instructions according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Tamper indicators (e.g., in the form of security stickers or security seals) may be placed on packaging for a physical item, or placed on the physical item itself, for the purpose of detecting whether the physical item has been tampered with. In some cases, a holographic image may be added to a tamper indicator to enhance the visual indication of tampering. In an example, if an attacker unseals the packaging of the physical item or opens a housing of the physical item, a tamper indicator may break, deform, or otherwise physically change in appearance to provide an indication that tampering has occurred. An attacker may attempt to bypass a tamper indicator ("original" tamper indicator") by using a solvent or applying heat with a heat gun to remove the tamper indicator for accessing a physical item. The attacker can subsequently re-apply the original tamper indicator or replace the original tamper indicator with a new tamper indicator that appears identical to the original tamper indicator. If the original tamper indicator can be re-applied or replaced after tampering, a recipient of the physical item would not be able to detect that tampering has occurred. If the physical item is an electronic device and the attacker introduced malware or replaced a physical component of the electronic device, then the attacker may use the electronic device to perform malicious activities on the electronic device or in a computing environment. Additionally, if the electronic device stores sensitive or confidential information, the recipient would not know that such information may have been subjected to unauthorized access.

In accordance with some implementations of the present disclosure, a tamper indication device includes a tamper visual layer that is physically deformable to visually indicate tampering. The tamper indication device further includes a control circuit having a wireless transceiver and a memory storing a secret. The secret was written to the memory of the tamper indication device by an entity at a secure location, such as in a manufacturing or assembly facility of a physical item on which the tamper indication device is affixed. The control circuit of the tamper indication device can receive a challenge value provided by an external device, such as after delivery of the physical item to a recipient (e.g., a customer, a distributor, a reseller, an integrator, etc.). The control circuit can generate a challenge response value based on the challenge value and the secret. For example, the control circuit can apply a one-way function on the challenge value and the secret. An example of a one-way function is a cryptographic hash function such as a Secure Hash Algorithm (SHA) function, a Message Digest function, or another type of a cryptographic hash function. Other examples of one-way functions include a Rabin function, a squaring modulo function, a cyclic redundancy check (CRC) 32 function, and so forth. Alternatively, the challenge response value can include a signature generated by signing the challenge value using the secret. The signing of the challenge value using the secret can use a private key stored at the tamper indication device, for example. The control circuit can store the challenge response value in the memory. The challenge response value is readable from the memory as part of a tamper detection process performed by the external device.

Techniques or mechanisms according to some examples of the present disclosure can improve the relevant technology of protecting physical items from tampering. A tamper indication device according to some examples of the present disclosure provides both a visual and electronic indication of tampering. The electronic indication provided by using a challenge response value derived from a secret in the tamper indication device and a challenge value supplied by an external device that is performing the tamper detection prevents an attacker from hacking the tamper indication device electronically for the purpose of preventing tamper detection.

The secret stored in the tamper indication device can be any value that is not easily derivable from information on the physical item being protected by the tamper indication device. For example, a packing slip or invoice may be provided with the physical item. The secret can be a value that does not appear on the packing slip or invoice. However, the secret is known to the manufacturer or assembler as well as to the intended recipient or distributor of the physical item.

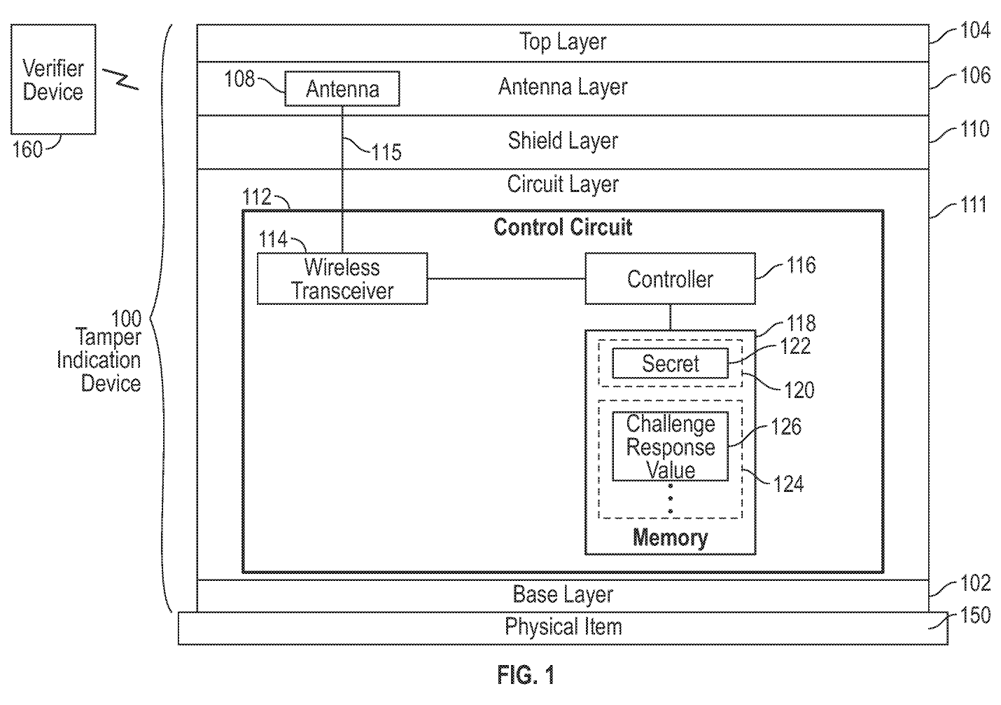

FIG. 1 is a block diagram of an example arrangement that includes a tamper indication device 100 mounted to a physical item 150. The example arrangement also includes a verifier device 160 to check whether tampering has occurred with respect to the tamper indication device 100. The verifier device 160 can include a smartphone, a tablet computer, a notebook computer, a desktop computer, or any other electronic device.

FIG. 1 shows a schematic side view of various layers that are part of the tamper indication device 100 according to some examples of the present disclosure. In other examples, the tamper indication device 100 can include a different arrangement of layers. For example, the layers may be arranged in a different order, and/or additional layers may be provided between the layers shown in FIG. 1.

The tamper indication device 100 include a base layer 102 and a top layer 104. The base layer 102 is contacted to the physical item 150 that is to be protected. In some examples, the base layer can be attached to the physical item 150 by an adhesive material, such as glue, an epoxy adhesive, a polyurethane adhesive, or any other type of adhesive material. In some examples, the tamper indication device 100 may be affixed to a latch that locks a movable panel of the physical item 150 to a housing of the physical item 150. If the latch is manipulated to open the movable panel, the tamper indication device 100 would be destroyed. In other examples, the tamper indication device 100 can be attached to packaging that if opened would destroy the tamper indication device 100. For example, the tamper indication device 100 can be provided under shipping tape. If the shipping tape is cut or the packaging is opened, the tamper indication device 100 would be destroyed.

The physical item 150 can be a protected item, such as an electronic device; a storage medium (e.g., a compact disk (CD) or a video digital disk (DVD), or a flash memory device containing information such as software, a movie, or other information; a purse; or any other type of item. Alternatively, the physical item to which the tamper indication device 100 is mounted can be the packaging for a protected item, such as a box or any other type of packaging.

In some examples, the base layer 102 can be easily torn such that any attempt to remove the tamper indication device 100 from the physical item 150 to which the tamper indication device 100 is affixed would result in the base layer 102 breaking apart. For example, the base layer 102 can be formed with perforations (e.g., holes, slots, or other types of perforations) that can cause shredding of the base layer 102 if the base layer 102 is removed from the physical item 150. The base layer 102 can be formed of a polystyrene. In other examples, the base layer 102 can be formed of polypropylene, vinyl, polyester, or another material.

The top layer 104 is formed of a material that is deformable in response to application of a solvent or elevated heat in an attempt by an attacker to remove the tamper indication device 100 from the physical item 150. Examples of solvents include acetone, ethyl acetate, or another type of solvent that is designed to break down an adhesive material that may be used to affix the tamper indication device 100 to the physical item 150. Elevated heat may be applied by a heat gun, for example. The top layer 104 may deform at a temperature greater than about 100° Fahrenheit (F), 150° F, 175° F, 200° F, and so forth. The top layer 104 can be formed using biaxially oriented polystyrene. In other examples, the top layer 104 can be formed of polypropylene, vinyl, polyester, or another material.

Each of the base layer 102 and the top layer 104 provides a tamper visual layer physically deformable to visually indicate tampering with the tamper indication device 100.

An antenna layer 106 is provided below the top layer 104. The antenna layer 106 includes an antenna 108 for emitting and receiving electromagnetic (EM) signals. The antenna 108 includes an electrically conductive material (e.g., a metal) of a specific pattern. In some examples, the antenna 108 can be a near field communication (NFC) antenna, a Radio Frequency Identification (RFID) antenna, or any other type of antenna for wireless signal transmissions.

The antenna 108 is provided below the top layer 104 but above a shield layer 110 that is configured to protect a control circuit 112 in a circuit layer 111 of the tamper indication device 100 from being scanned using imaging, such as X-ray imaging (a specific type of X-ray imaging is computed tomography (CT) scan imaging), or any other type of imaging that uses EM radiation at target wavelengths. For example, X-ray signals have wavelengths in the range of 0.01 to 10 nanometers.

The shield layer 110 is opaque to the EM waves at the target wavelengths of imaging systems such as X-ray scanners (e.g., CT scanners), or other types of imaging scanners. In some examples, the shield layer 110 can include a metal (and possibly other materials) that provides the shielding. For example, the shield layer 110 can be formed of a plastic (or another non-conductive material such as rubber, etc.) that is metalized.

The control circuit 112 is below the shield layer 110. Any attempt by an attacker to scan the content of the control circuit 112 using an imaging system is blocked by the shield layer 110. The control circuit 112 includes a wireless transceiver 114, which is electrically connected (such as through a via 115 extending through the shield layer 110) to the antenna 108.

The control circuit 112 further includes a controller 116 connected to the wireless transceiver 114. The wireless transceiver 114 can transmit and receive signals using the antenna 108. The control circuit 112 additionally includes a memory 118, such as an NFC memory, an RFID memory, registers, or other storage elements. The memory 118 can include one or more memory devices.

The memory 118 may wear out after some number of accesses (e.g., 50,000 or any other number of accesses). A memory device such as an erasable and programmable read-only memory (EPROM) device, an electrically erasable and programmable read-only memory (EEPROM) device, or a flash memory device wears out after more than some number of accesses. The feature of burning out prevents an attacker from attempting to brute-force reverse engineer the secret 122 by repeatedly writing different values to the memory 118 and reading resultant response values. Once the memory 118 wears out, the memory 118 may no longer be able to reliably store data.

The controller 116 can communicate with an external device (that is external of the tamper indication device 100), such as the verifier device 160, through the wireless transceiver 114. Information received by the controller 116 through the wireless transceiver 114 can include commands sent by an external device such as the verifier device 160. Examples of commands include a write command to write a value to the memory 118 of the control circuit 112, or a read command to read a value from the memory 118.

The memory 118 includes a secret memory region 120 in which a secret 122 can be stored. The secret memory region 120 can only be written once, as controlled by the controller 116. In some examples, in response to a write command to write a target value to the memory 118, the controller 116 determines whether the secret memory region 120 is empty. An "empty" memory region refers to a memory region that is without any stored value or contains a predefined null value, such as all zeros or some other predefined value indicating that the memory region has not previously been written. If the secret memory region 120 is empty, the controller 116 writes the target value (e.g., the secret 122) to the secret memory region 120. If the secret memory region 120 is not empty, the controller 116 blocks the attempted write to the secret memory region 120. Note that the content of the secret memory region 120 cannot be read to prevent unauthorized access of the secret 122 by an unauthorized entity.

After the secret memory region 120 has been written with the secret 122, any subsequent write command causes a value to be written to a readable memory region 124 of the memory 118. The readable memory region 124 stores values that are readable by an external device, such as the verifier device 160, that issues read commands to the tamper indication device 100. The memory regions of the memory 118 can be arranged as blocks, including a block corresponding to the secret memory region 120, and additional block(s) corresponding to the readable memory region 124.

In some examples of the present disclosure, the controller 116 can generate a challenge response value 126 based on the secret 122 and a challenge value received with a write command from the verifier device 160. For example, the controller 116 can apply a one-way function (e.g., a cryptographic hash function) on the received challenge value and the secret 122 to generate the challenge response value 126 that is written to the readable memory region 124. In other examples, the challenge response value can be generated in a different way, such as by signing the challenge value with the secret 122 to produce a signature that can be stored in the readable memory region 124. The controller 116 writes the challenge response value 126 to the readable memory region 124.

The challenge value from the verifier device 160 can be any arbitrary value generated at the verifier device 160. For example, the challenge value can include a current time, and/or a random value generated by a pseudorandom generator at the verifier device 160.

The verifier device 160 (or multiple verifier devices) can issue multiple write commands (with respective challenge values) to the tamper indication device 100. The controller 116 responds to each write command by generating a respective challenge response value and writing the respective challenge response value to the next block of the readable memory region 124. In an example, as the physical item 150 traverses a supply chain, different entities can use respective verifier devices to write challenge values to the tamper indication device 100, followed by reading corresponding challenge response values to determine whether tampering with the tamper indication device 100 has occurred.

The verifier device 160 can issue a read command to the tamper indication device 100 to read the challenge response value 126 stored in the readable memory region 124. In response to the read command, the controller 116 retrieves the challenge response value 126 from the memory 118 and sends the challenge response value 126 through the wireless transceiver 114 to the verifier device 160.

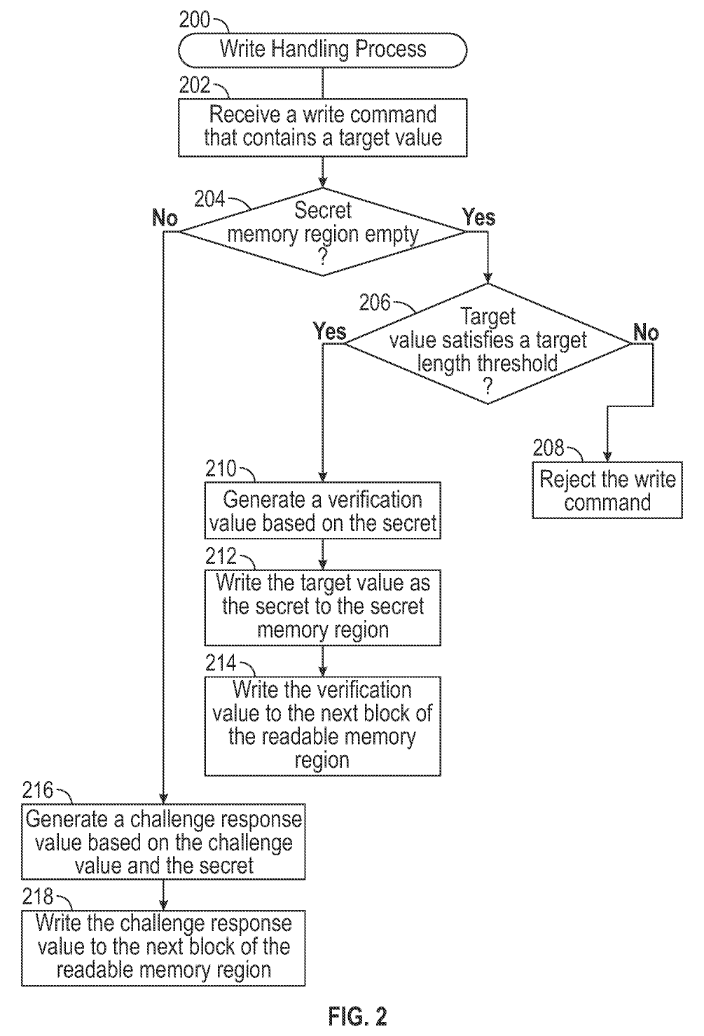

The following discussion refers to FIGS. 1 and 2. FIG. 2 is a flow diagram of a write handling process 200 of the controller 116 according to some examples of the present disclosure. The controller 116 receives (at 202) a write command that contains a target value. Note that the write command may be issued either at a secure location (e.g., at a location of a manufacturer or assembler of the physical item 150) or at a location later in the supply chain of the physical item 150 (e.g., at a site of an intended recipient or an intermediate distributor).

The target value can include the secret 122 to be written to the secret memory region 120 memory region 120 of the memory 118 at the secure location. Alternatively, the target value may be included with a write command issued by the verifier device 160 to perform tamper detection of the tamper indication device 100.

The controller 116 determines (at 204) whether the secret memory region 120 memory region 120 is empty. If the controller 116 determines (at 204) that the secret memory region 120 memory region 120 is empty, the controller 116 determines (at 206) whether the target value provided with the write command satisfies a target length threshold for a secret. The target value satisfies the target length threshold if the target value has a length that is equal to or greater than a specified length of the target length threshold.

If the controller 116 determines (at 206) that the target value does not satisfy the target length threshold, the controller 116 rejects (at 208) the write command. The controller 116 can send a write reject indication to an external device that issued the write command.

However, if the controller 116 determines (at 206) that the target value satisfies the target length threshold, the controller 116 generates (at 210) a verification value based on the secret 122, such as by applying a one-way function on the secret 122 or signing the secret 122. The controller writes (at 212) the target value as the secret 122 to the secret memory region 120, and the controller writes (at 214) the verification value to the next block of the readable memory region 124. After the secret 122 has been written to the secret memory region 120, no further writes to the secret memory region 120 are allowed by the controller 116.

The verification value written to the readable memory region 124 can be read by an entity (e.g., associated with the manufacturer or assembler) that is affixing the tamper indication device 100 to the physical item 150. For example, the entity can confirm based on the verification value that the tamper indication device 100 is not defective. If the verification value matches an expected value, the tamper indication device 100 is not defective. However, if the verification value does not match an expected value, the tamper indication device 100 is defective.

If the controller 116 determines (at 204) that the secret memory region 120 is not empty (e.g., due to the secret 122 already having been written to the secret memory region 120), the received write command is from the verifier device 160 for determining whether the tamper indication device 100 has been tampered with. In this case, the target value of the received write command is a challenge value.

The controller 116 generates (at 216) a challenge response value based on the challenge value and the secret 122 stored in the memory 118. The controller 116 writes (at 218) the challenge response value to the next block of the readable memory region 124.

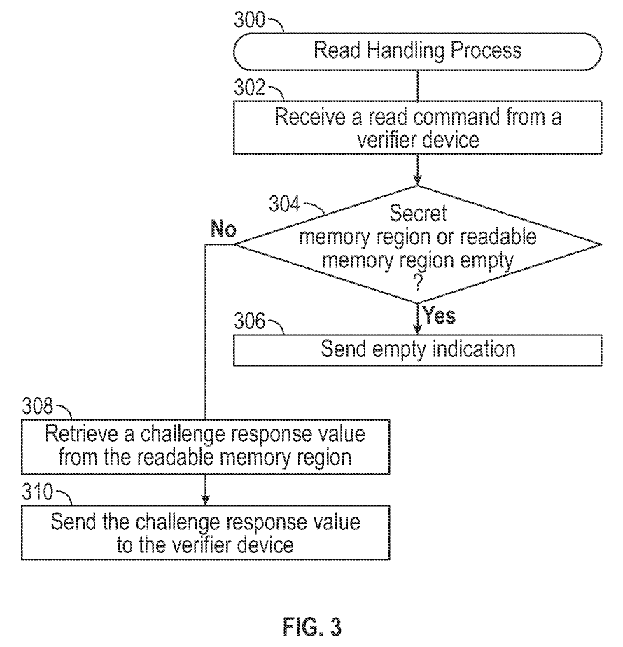

The following discussion refers to FIGS. 1 and 3. FIG. 3 is a flow diagram of a read handling process 300 of the controller 116. The controller 116 receives (at 302) a read command issued by the verifier device 160. In response to read command, the controller 116 determines (at 304) whether either the secret memory region 120 is empty or the readable memory region 124 is empty. If the secret memory region 120 is empty or the readable memory region 124 is empty, this indicates that the tamper indication device 100 has not been programmed and thus the controller 116 sends (at 306) an empty indication back to the verifier device 160.

However, if both the secret memory region 120 and the readable memory region 124 are not empty, the controller 116 retrieves (at 308) the challenge response value 126 from the readable memory region 124 and sends (at 310) the challenge response value 126 back to the verifier device 160.

The verifier device 160 can determine whether tampering has occurred with the tamper indication device 100 in the following manner. The verifier device 160 can compute a reference value based on the challenge value and a reference secret stored at the verifier device 160. The reference secret should be the same as the secret 122 at the tamper indication device 100 if tampering has not occurred with the tamper indication device 100.

The reference value can be: (1) a value computed by applying the one-way function to the challenge value and the reference secret, or (2) a value including the challenge value and the reference secret. The reference value is compared to a comparison value derived from the challenge response value received from the tamper indication device 100. For scenario (1), the comparison value is the challenge response value. For scenario (2), the comparison value includes the challenge value and the secret 122 extracted by decrypting a signature using a public key corresponding to the private key used to sign the challenge value and the secret 122 at the tamper indication device 100.

The verifier device 160 compares the comparison value to the reference value. If the comparison value matches the reference value, the verifier device 160 can output a match indication that indicates no tampering has occurred with the tamper indication device 100. However, if the comparison value does not match the reference value, the verifier device 160 can output a mismatch indication that indicates tampering has occurred with the tamper indication device 100. The match or mismatch indication can be displayed in a user interface of the verifier device 160, or alternatively, the verifier device 160 can send the match or mismatch indication to a target device, such as a remote server or another user device.

A similar read handling process may be performed for retrieving a verification value by an entity associated with a manufacturer or assembler for verifying that the tamper indication device 100 is not defective prior to affixing the tamper indication device 100 to the physical item 150.

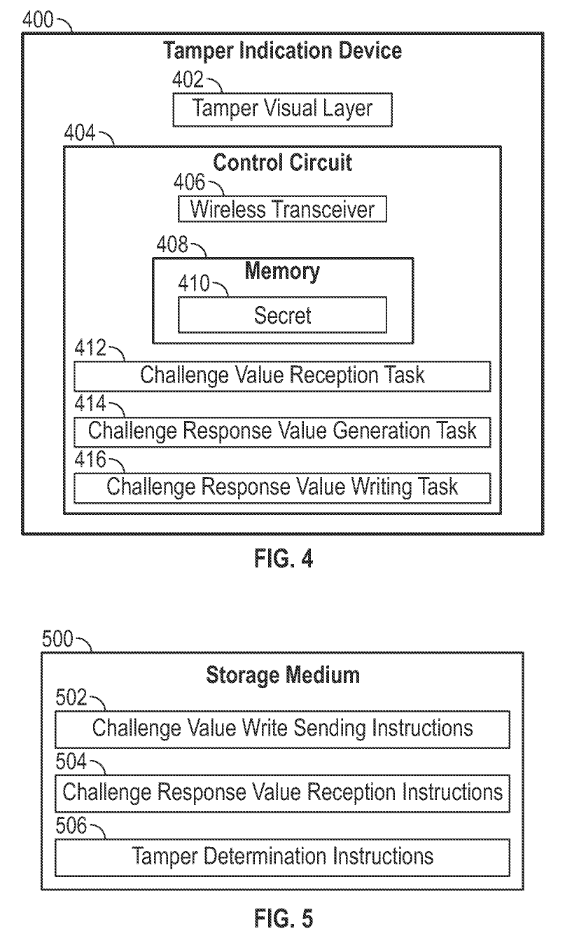

FIG. 4 is a block diagram of a tamper indication device 400 according to some examples of the present disclosure. An example of the tamper indication device 400 is the tamper indication device 100 of FIG. 1.

The tamper indication device 400 includes a tamper visual layer 402 physically deformable to visually indicate tampering. An example of the tamper visual layer 402 is one or both of the top layer 104 or base layer 102 in FIG. 1.

The tamper indication device 400 includes a control circuit 404, which includes a wireless transceiver 406 and a memory 408 storing a secret 410. The control circuit 404 can perform various tasks. The tasks of the control circuit 404 may be performed by a controller, such as the controller 116 of FIG. 1.

The tasks of the control circuit 404 include a challenge value reception task 412 to receive a challenge value provided by an external device. An example of the external device is the verifier device 160 of FIG. 1. The challenge value can be included in a write command transmitted wirelessly by the external device to the tamper indication device 400.

The tasks of the control circuit 404 include a challenge response value generation task 414 to generate a challenge response value based on the challenge value and the secret. For example, the challenge response value is computed by applying a function to the challenge value and the secret, where the function can be a one-way function or a signature function to sign the challenge value and the secret.

The tasks of the control circuit 404 include a challenge response value writing task 416 to store the challenge response value in the memory 408. The challenge response value readable from the memory 408 as part of a tamper detection process performed by the external device.

In some examples, the wireless transceiver 406 receives the challenge value from the external device and sends the challenge response value to the external device.

In some examples, the wireless transceiver 406 receives the challenge value with a write command from the external device, and sends the challenge response value to the external device in response to a read command from the external device.

In some examples, the secret 410 in the memory 408 is not readable by any external device.

In some examples, the secret 410 is stored in a write-once region (e.g., the secret memory region 120 of FIG. 1) of the memory 408. The control circuit 404 can, responsive to a write command of a target value, determine whether the write-once region is empty. Based on the write-once region being empty, the control circuit 404 can write the target value as the secret 410 to the write-once region of the memory 408.

In some examples, the control circuit 404 can determine whether the target value satisfies a target length threshold. Responsive to the target value satisfying the target length threshold, the control circuit 404 can write the target value as the secret 410 to the write-once region of the memory 408. Responsive to the target value not satisfying the target length threshold, the control circuit 404 can send a write reject indication to the external device.

In some examples, the control circuit 404 can, responsive to the write command of the target value, generate a verification value based on the secret 410. The control circuit 404 can write the verification value to a readable region of the memory for use in verifying the integrity of the tamper indication device 400.

In some examples, the tamper visual layer 402 is deformable due to an application of a solvent or heat.

In some examples, the tamper indication device 400 includes a shield layer above the control circuit 404, the shield layer being opaque to imaging EM wavelengths.

FIG. 5 is a block diagram of a non-transitory machine-readable or machine-readable storage medium 500 storing machine-readable instructions that upon execution cause an electronic device to perform various tasks. An example of the electronic device is the verifier device 160 of FIG. 1.

The machine-readable instructions include challenge value write sending instructions 502 to send a write command to a wireless transceiver of a tamper indication device on a physical item protected by the tamper indication device. The write command includes a challenge value.

The machine-readable instructions include challenge response value reception instructions 504 to receive, at the electronic device, a challenge response value from the wireless transceiver of the tamper indication device. The challenge response value is generated based on the challenge value and a secret stored in a memory of the tamper indication device.

The machine-readable instructions include tamper determination instructions 506 to determine, based on the challenge response value, whether tampering with the tamper indication device has occurred. In some examples, the determining of whether tampering with the tamper indication device has occurred is based on comparing a comparison value and a reference value, where the reference value is obtained at the electronic device based on the challenge value and a reference secret stored at the electronic device, and the comparison value is obtained at the electronic device based on the challenge response value received from the tamper indication device.

In some examples, the reference value is based on applying a one-way function on the challenge value and the reference secret, and the comparison value is the challenge response value received from the tamper indication device.

In further examples, the reference value includes the challenge value and the reference secret, and the comparison value is obtained by decrypting a signature in the challenge response value.

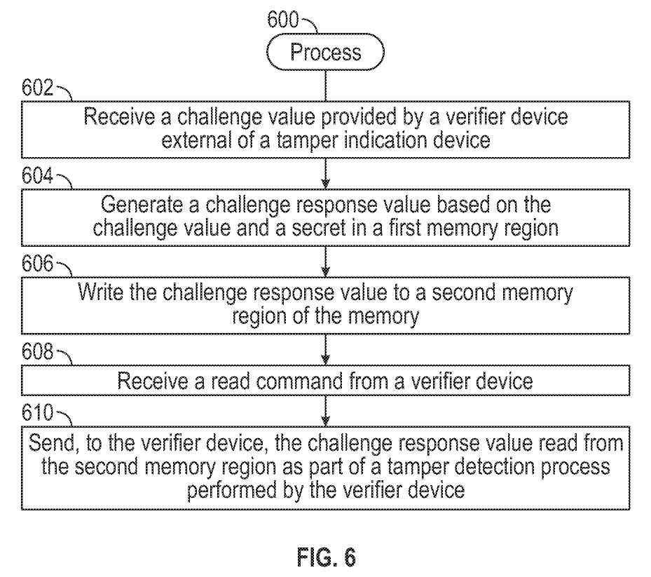

FIG. 6 is a flow diagram of a process 600 according to some examples of the present disclosure. The process 600 may be performed by the controller 116 of the control circuit 112 of FIG. 1, for example.

The process 600 includes receiving (at 602) a challenge value provided by a verifier device external of a tamper indication device. The tamper indication device includes a memory including a first memory region (e.g., 120 in FIG. 1) storing a secret. The controller can prevent any read of the secret from the first memory region.

The process 600 includes generating (at 604) a challenge response value based on the challenge value and the secret. The challenge response value can be generated using a one-way function or a signature function, for example.

The process 600 includes writing (at 606) the challenge response value to a second memory region of the memory. An example of the second memory region is the readable memory region 124 of FIG. 1.

The process 600 includes receiving (at 608) a read command from a verifier device. As a response to the read command, the process 600 includes sending (at 610), to the verifier device, the challenge response value read from the second memory region as part of a tamper detection process performed by the verifier device.

A memory device can refer to any of the following: a dynamic random access memory (DRAM) device, a static random access memory (SRAM) device, an EPROM device, an EEPROM device, a flash memory device, or any other type of storage.

FIGS. 2, 3, and 6 are flow diagrams of processes including tasks performed in depicted orders. In other examples, the tasks of any of the processes may be performed in a different order, some of the tasks may be omitted, and other tasks may be added.

As used here, a "controller" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a "controller" can refer to a combination of one or more hardware processing circuits and machine-readable instructions (software and/or firmware) executable on the one or more hardware processing circuits.

A hardware processor can include a microprocessor, a core of a multi-core microprocessor, a microcontroller, a programmable integrated circuit, a programmable gate array, or another hardware processing circuit.

Machine-readable instructions executable on a hardware processor can refer to the instructions executable on a single hardware processor or the instructions executable on multiple hardware processors.

A hardware processor performing a task can refer to a single hardware processor performing the task or multiple hardware processors performing the task.

A storage medium (e.g., 500 in FIG. 5) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A tamper indication device comprising:
a tamper visual layer physically deformable to visually indicate tampering; and
a control circuit comprising a wireless transceiver and a memory storing a secret, the control circuit to:
receive a challenge value provided by an external device;
generate a challenge response value based on the challenge value and the secret; and
store the challenge response value in the memory, the challenge response value readable from the memory as part of a tamper detection process performed by the external device.

2. The tamper indication device of claim 1, wherein the challenge response value is based on a function applied on the challenge value and the secret.

3. The tamper indication device of claim 2, wherein the function includes a one-way function applied on the challenge value and the secret.

4. The tamper indication device of claim 2, wherein the function includes a signature function to sign the challenge value and the secret.

5. The tamper indication device of claim 1, wherein the wireless transceiver is to receive the challenge value and send the challenge response value to the external device.

6. The tamper indication device of claim 5, wherein the wireless transceiver is to:
receive the challenge value with a write command from the external device, and
send the challenge response value to the external device in response to a read command from the external device.

7. The tamper indication device of claim 1, wherein the secret in the memory is not readable by any external device.

8. The tamper indication device of claim 1, wherein the secret is stored in a write-once region of the memory, the control circuit to:
responsive to a write command of a target value, determine whether the write-once region is empty; and
based on the write-once region being empty, write the target value as the secret to the write-once region of the memory.

9. The tamper indication device of claim 8, wherein the control circuit is to:
determine whether the target value satisfies a target length threshold; and
responsive to the target value satisfying the target length threshold, write the target value as the secret to the write-once region of the memory.

10. The tamper indication device of claim 8, wherein the control circuit is to:
responsive to the write command of the target value, generate a verification value based on the secret; and
write the verification value to a readable region of the memory.

11. The tamper indication device of claim 1, wherein the tamper visual layer is deformable due to an application of a solvent or heat.

12. The tamper indication device of claim 1, wherein the secret is written to the memory by an entity at a secure location.

13. The tamper indication device of claim 1, further comprising:
a shield layer above the control circuit, the shield layer being opaque to imaging electromagnetic wavelengths.

14. A non-transitory machine-readable storage medium comprising instructions that upon execution cause an electronic device to:
send a write command to a wireless transceiver of a tamper indication device on a physical item protected by the tamper indication device, the write command comprising a challenge value;
receive, at the electronic device, a challenge response value from the wireless transceiver of the tamper indication device, the challenge response value generated based on the challenge value and a secret stored in a memory of the tamper indication device; and
determine, based on the challenge response value, whether tampering with the tamper indication device has occurred.

15. The non-transitory machine-readable storage medium of claim 14, wherein the instructions upon execution cause the electronic device to:
obtain a reference value at the electronic device based on the challenge value and a reference secret stored at the electronic device;
obtain a comparison value at the electronic device based on the challenge response value received from the tamper indication device;
compare the comparison value to the reference value,
wherein the determining of whether tampering with the tamper indication device has occurred is based on the comparing.

16. The non-transitory machine-readable storage medium of claim 15, wherein the reference value is based on applying a one-way function on the challenge value and the reference secret, and the comparison value is the challenge response value received from the tamper indication device.

17. The non-transitory machine-readable storage medium of claim 15, wherein the reference value includes the challenge value and the reference secret, and the comparison value is obtained by decrypting a signature in the challenge response value.

18. A method comprising:
receiving, by a controller of a tamper indication device, a challenge value provided by a verifier device external of the tamper indication device, the tamper indication device comprising a memory including a first memory region storing a secret;
generating, by the controller, a challenge response value based on the challenge value and the secret;
writing, by the controller, the challenge response value to a second memory region of the memory;
receiving, by the controller, a read command; and
as a response to the read command, sending, by the controller to the verifier device, the challenge response value read from the second memory region as part of a tamper detection process performed by the verifier device.

19. The method of claim 18, wherein the generating of the challenge response value is based on:
applying a one-way function to the challenge value and the secret, or
signing the challenge value and the secret.

20. The method of claim 18, wherein the controller prevents any read of the secret from the first memory region.
